(19) United States
(12) Patent Application Publication
(10) Pub. No.: US 2011/0295630 A1
(43) Pub. Date: Dec. 1, 2011

(54) SYSTEM AND METHOD FOR CREATING FINANCIAL SECURITIES BACKED BY CASHFLOW DERIVED FROM ENERGY SAVINGS

(76) Inventors: Joe Cheng, Redondo Beach, CA (US); Michael Gorder, Westlake Village, CA (US)

(21) Appl. No.: 13/100,844

(22) Filed: May 4, 2011

Related U.S. Application Data
(60) Provisional application No. 61/331,102, filed on May 4, 2010.
(60) Provisional application No. 61/331,119, filed on May 4, 2010.

(51) Int. Cl. G06Q 10/00; G06Q 40/00

(52) U.S. Cl. 705/7.11; 705/35

(57) ABSTRACT

A method and system are provided for creating and measuring cashflows based on energy saving improvements made to a structure, e.g., a building, underground facility, or a ship. In one implementation, the invention is directed to a system and method for improving and measuring the energy efficiency of a structure. The system and method may be implemented in hardware or on a computer-readable medium that is non-transitory. A method and system for creating a financial security collateralized by such cashflows associated with an individual structure are disclosed. A method and system for creating a financial security collateralizing a pool of multiple financial securities discussed above are disclosed.

### CROSS-REFERENCE TO RELATED APPLICATIONS

This application claims benefit of priority from U.S. Provisional Patent Application Ser. No. 61/331,102, filed May 4, 2010, entitled “SYSTEM AND METHOD FOR OPTIMIZING THE ENERGY EFFICIENCY OF A BUILDING”, and U.S. Provisional Patent Application Ser. No. 61/331,119, filed May 4, 2011, entitled “FINANCIAL INSTRUMENTS”, both of which are incorporated by reference herein in their entirety.

### BACKGROUND OF THE INVENTION

In today's economy, energy saving is highly important due to the cost of energy. In addition, the requirements, and in many cases, rules and regulations, requiring the implementation of green or other energy efficient technologies mandates that new technologies be developed and utilized in this field.

### SUMMARY OF THE INVENTION

Systems and methods described here provide ways to create cashflows based on energy saving improvements to a structure, e.g., a building, underground facility, or a ship. Analysis is made for potential energy savings, and energy efficiency improvement may be implemented. Any energy efficiency improvement can generate new cashflows, in term of reduced energy expenditure. An energy consulting service may implement energy saving methods to the structure or provide financing to implement the energy saving methods in exchange for a compensation, including receiving a fraction of the savings generated by the energy savings. This compensation to the energy consulting service is referred as cashflow or cashflows. In addition, cash flows may be employed as received from multiple sources, including energy savings, tax credits, and greenhouse gas cap and trade credits. These cashflows can be used to create a financial security. Further, multiple such financial securities can be pooled together to generate a new financial security.

In more detail, the invention is directed to a system and method for improving and measuring the energy efficiency of a structure. The system and method may be implemented in hardware or on a computer-readable medium that is non-transitory. In another aspect, methods and systems are provided for creating a financial security collateralized by such cashflows associated with an individual or with plural structures. In a further aspect, methods and systems are provided for creating a separate financial security collateralizied by a pool of multiple financial securities, each collateralized by cashflows generated by energy savings.

An implementation of the current system and method employ the plural cash flows received from all sources, associated with energy savings from an individual or plural structures, to create a financial security. This security entitles the holder to receive the cashflows Multiple such securities may be pooled together to create a new security (i.e. the new security is collateralized by the multiple individual securities, each in turn is collateralized by the energy saving cashflows from the structures).

In some implementations, the innovation is derived at least by the energy savings, tax credits, and “cap and trade” credits. The value of the individual financial securities will become more valuable if 1) the cost of energy increases, 2) more employees are hired (because there are more savings), 3) greenhouse gas cap and trade credit is increased.

The system and method evaluates the energy efficiency of a building, and measures the energy consumption by auditing past utilities bills, or using actual measurement. Various computer implemented applications may be employed to make this measurement and to project future energy usage.

The system and method then determines strategies for energy efficiency renovation and makes proposals, e.g., to the building owner, for such improvement. These proposals may be automatically generated by the system and method and may also be based on user input. For example, a processor may use the local memory to run an application stored in memory or on a hard drive that analyzes the energy consumption and is further used to create the proposals. User input may be provided by way of a drop-down menu such that the user can choose the type of building, the construction of the building, the current method of heating and cooling, the current type of insulation, and/or any other type of variable that may bear on the proposals created.

The system and method may provide the consulting and renovation services to the owner of the building. For example if the cost of the renovation and consulting services are $1M, due and payable to the business, the building owner may be incentivized to use the renovation and consulting services by spreading out the cost of the same over a predetermined number of years, and the annual cost may be based on a fraction of the amount saved in energy bills. In this way, any financial hurdles to the use of the business and its associated system and method are removed. For example, if the energy cost savings is $250 k per year, the business may receive, e.g., 75% of the savings until it recoups its investment. Following the recouping, the savings may be divided 50%/50% thereafter for a number of years, e.g., 15 years thereafter.

To protect the investment, the system and method of the business could generate a lien on the building until the obligations of the building owner are fulfilled. Various options may be put in place in case the building owner sells the building. For example, a present value of the projected remaining cashflow may be calculated and paid off, the cash flow obligation may be passed on to the next owner, who would likewise reap the benefits of the system and method.

Thus, in this system and method, new benefits are created and provided to building owners. The sharing of energy benefits may due at least to the following components:

Energy saved—before and after. The saving is calculated by difference of usage multiplied by the current energy price. For example if all other factors are the same, with only the number of employees being the variable, the energy saved is calculated as follow:

# total current employees*(Old Kw-hr/employee−New Kw-hr/employee)*energy price, where Old Kw-hr/employee is the usage rate pre-renovation, New Kw-hr/employee is the usage rate post-renovation.

### BRIEF DESCRIPTION OF THE DRAWINGS

FIG. 1 is a flowchart illustrating steps employed to create a cash flow based on energy savings.

FIG. 2 illustrates the employment of a cash flow created by energy savings to create an energy-saving-based security (ESBS).

FIG. 3 illustrates using multiple energy-saving-backed securities to create an ESBS-backed collateral security (EBCS).

### DETAILED DESCRIPTION

The present invention relates generally to systems and methods to create energy savings in a structure, as well as ways of monetizing such savings. A structure may include, for example, a building, underground structure or a ship, as well as other structures.

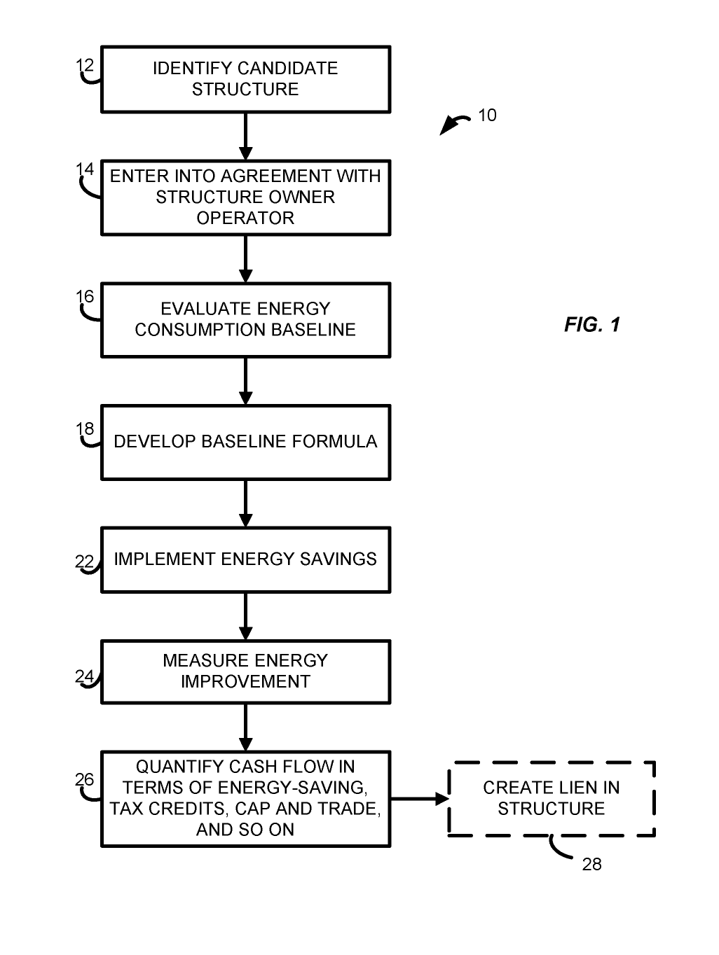

FIG. 1, showing flowchart 10, and the below description illustrate exemplary steps to create energy savings and cashflows.

In a first step (step 12), a candidate structure is selected, e.g., based on energy saving potential. In a second step (step 14), a provider of energy efficiency improvement enters into an agreement with the owner or the operator of the structure, including details as to how the cashflow created by the energy efficiency improvement shall be divided. This agreement is where the cashflows are created by obligating the owner of the structure to compensate the provider of energy efficiency improvement.

In a third step (step 16), the system and method may create an energy consumption baseline by studying past utilities bills, energy consumption records, or using energy measurement over a period. The gathering and analysis of the data may be implemented on hardware and a computer such as energy measuring devices and a computer to calculate the energy consumption. In a fourth step (step 18), the system and method may employ measurements to create an energy consumption formula that is made up of two components: 1) a fixed consumption component and 2) a variable consumption component. The fixed consumption component may be a constant. The variable consumption component may account for structure characteristics such as square footage, 24×7 equipment usage, hours of operations, equipment usage hours, number of employees, etc. An example of the formula for energy consumed during a period is

BEC=FC+A*SF+B*EB+C*EC+D*HD+E*HE+F*NE

Where:

BEC is the total baseline energy consumption;

FC is a fixed component, a constant (this constant may be adjusted from future energy evaluation of a structure);

A is a constant;

SF is the square footage (variable 1);

B is a constant;

EB is the number of equipment B that operates continuously (variable 2);

C is a constant;

EC is the number of equipment C that operates continuously (variable 3);

D is a constant;

HD is the hours of operations of equipment D during the period (variable 4);

E is a constant;

HE is the hours of operations of equipment E during the period (variable 5);

F is a constant;

NE is the number of employees (variable 6);

This formula may have many other variable factors and may include factors of higher orders (2^{nd} order, 3^{rd} order, etc.). Other factors will be apparent to one of ordinary skill in the art given this teaching and disclosure.

A method and system may be employed to measure these constants by measuring the energy consumption over a period of time and finding the best fit formula to describe the energy consumption. This formula maybe developed by gathering the data and performing a statistical technique using a computer to provide a better-fit model. The statistical technique may include, e.g., least-squares fitting or various regression techniques.

In a fifth step, an energy efficiency improvement is implemented (step 22), based on an evaluation on the structure, operations, and business processes. The reduction is achieved by 1) making modifications to the structure, such as by installing insulation materials, 2) changing or installing equipment such as by using more energy efficient equipment, 3) changing business processes such as by changing manufacturing processes, developing different consumption habits, and switching operating procedures.

In a sixth step, the reduced energy used (in kilowatts-hours or other units) and measured may be used and compared with the baseline energy (step 24) as follows:
1. Applying the formula for Baseline Energy Consumption using the old constants but with revised variables (e.g. number of employees) based on the most current status. This may be the method used to calculated imputed energy usage if no energy saving method is used (i.e. the old way of energy consumption).
2. Energy saved is defined by subtracting the energy used (using actual utility bills or measurements) after energy saving implementation during a comparable period, from the imputed usage above.

In a seventh step, a new cashflow created is based on the energy saved (step 26). However this new cashflow is calculated as follow:
1. Applying the formula for Baseline Energy Consumption using the old constants but with revised variables (e.g. number of employees) based on the most current status.
2. Using the current energy cost to calculate the cost based in imputed usage (if no energy saving method is used).

A new cashflow is defined by subtracting the new (actual) cost from the imputed cost from above. However, multiple cashflows may result by receiving other benefits such as tax credits, and cap and trade credits.

In an eighth step, a lien may be put on the structure (step 28), based on the terms of the agreement negotiated in step 14.

This system and method may establish systems and methods to provide consulting and energy saving implementation to the operator or owner of a structure. For example, if the cost of the consultation and implementation is $1M, due and payable to the energy savings implementor, and the Owner could realize saving of $250,000 a year, e.g., in energy savings and tax benefits, the Owner may be incentivized to use the implementation.

The implementor may provide service or financing to the Owner in exchange for a fraction of the cashflows generated by the energy savings and other benefits over a period of time.

These cashflows are based on energy savings and other benefits on a structure and maybe secured by the equity of the structure. Moreover, an energy saving based security (“ESBS”) may be created based on these cashflows. This security may entitle its owner to the right to such cashflows. This security maybe traded and its value may be based on the history and projection of the future cashflows.

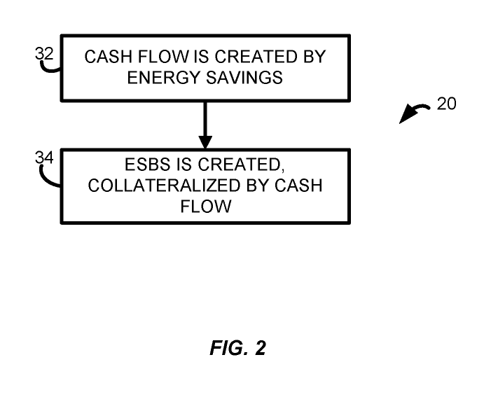

The process to create such an ESBS is depicted in FIG. 2. In the flowchart 20 of FIG. 2, a first step is that a cash flow is created as noted above in FIG. 1 by a savings of energy (step 32). Of course, FIG. 1 is exemplary and in the method of FIG. 2 any number of types of cash flows created by energy savings may be employed. A next step is that an energy savings backed security (ESBS) (step 34) may be created, which is collateralized by the cash flow created in step 32.

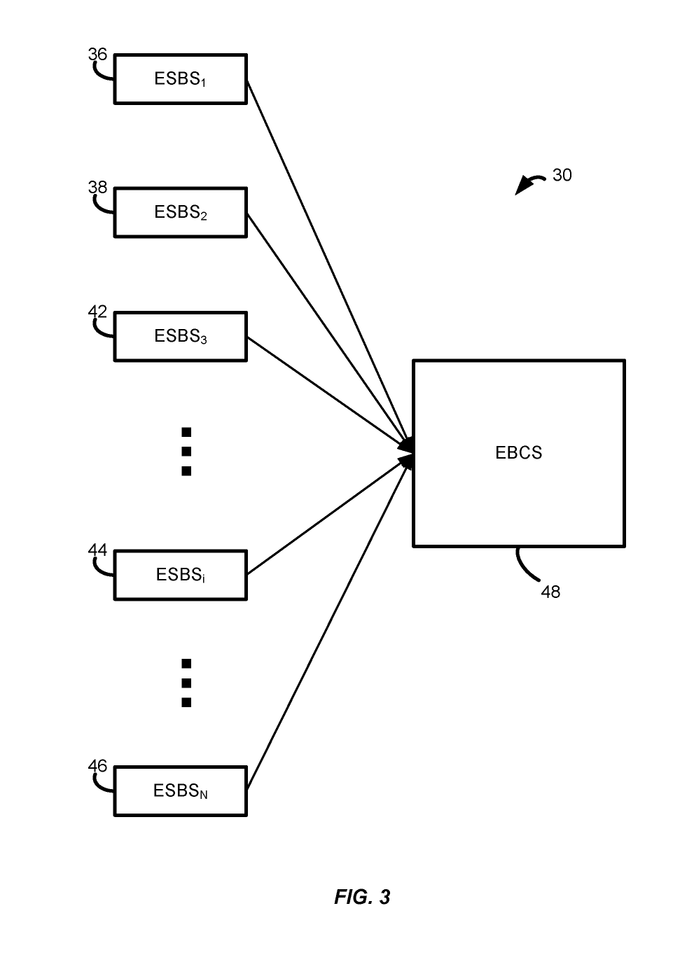

Multiple ESBSs can be pooled together. This pool can then be used to create a new security, such as a bond, to be collateralized by this pool of individual ESBSs. In other words, this is an ESBSs Backed Collateralized Security (“EBCS”). The process of creating an EBCS is depicted in the diagram 30 of FIG. 3, where a number of ESBSs 36-46 are combined together to create an EBCS 48. In this process an arbitrary large pool of N ESBSs may be used as collaterals to create an EBCS.

The system and method may be fully implemented in any number of computing devices. Typically, instructions are laid out on computer readable media, generally non-transitory, and these instructions are sufficient to allow a processor in the computing device to implement the method of the invention. The computer readable medium may be a hard drive or solid state storage having instructions that, when run, are loaded into random access memory. Inputs to the application, e.g., from the plurality of users or from any one user, may be by any number of appropriate computer input devices. For example, users may employ a keyboard, mouse, touchscreen, joystick, trackpad, other pointing device, or any other such computer input device to input data relevant to the calculations. Data may also be input by way of an inserted memory chip, hard drive, flash drives, flash memory, optical media, magnetic media, or any other type of file-storing medium. The outputs may be delivered to a user by way of a video graphics card or integrated graphics chipset coupled to a display that maybe seen by a user. Alternatively, a printer may be employed to output hard copies of the results. Given this teaching, any number of other tangible outputs will also be understood to be contemplated by the invention. For example, outputs may be stored on a memory chip, hard drive, flash drives, flash memory, optical media, magnetic media, or any other type of output. It should also be noted that the invention may be implemented on any number of different types of computing devices, e.g., personal computers, laptop computers, notebook computers, net book computers, handheld computers, personal digital assistants, mobile phones, smart phones, tablet computers, and also on devices specifically designed for these purpose. In one implementation, a user of a smart phone or wi-fi-connected device downloads a copy of the application to their device from a server using a wireless Internet connection. An appropriate authentication procedure and secure transaction process may provide for payment to be made to the seller. The application may download over the mobile connection, or over the WiFi or other wireless network connection. The application may then be run by the user. Such a networked system may provide a suitable computing environment for an implementation in which a plurality of users provide separate inputs to the system and method. In the below system where energy is monitored, the plural inputs may allow plural energy sources to be monitored at one time.

1. A computer-based method of evaluating energy savings, comprising:
a. determining an energy consumption baseline;
b. developing a baseline formula using the determined energy consumption baseline using a computing device;
c. using the developed baseline formula to determine a value of energy consumption following a change in at least one variable in the developed baseline formula; and
d. calculating a cost savings based on the determined energy consumption baseline and the value of energy consumption following the change.

2. The method of claim 1, wherein the baseline formula includes a fixed consumption component and one or multiple variable consumption components.

3. The method of claim 1, wherein the determining an energy consumption baseline includes measuring energy consumption.

4. The method of claim 2, comprising calculating energy saved based on the imputed energy consumption and actual consumption.

5. The method of claim 1, further comprising calculating a cash flow based on the calculated cost savings.

6. The method of claim 5, further comprising creating an energy saving backed security collateralized by the cash flow.

7. The method of claim 6, further comprising creating a financial security collateralized by a pool of energy saving backed securities.

8. The method of claim 5, further comprising calculating the cash flow based on a value selected from the group consisting of tax credits or greenhouse gas cap and trade credits.

9. The method of claim 1, wherein the determining includes determining the energy consumption baseline using historical values of energy consumption.

10. The method of claim 1, wherein the developing a baseline formula includes determining values of constants in the baseline formula.

11. The method of claim 10, where the constants are determined using a least squares fitting.

12. The method of claim 1, wherein the baseline formula is of the form:
a. BEC=FC+A*SF+B*EB+C*EC+D*HD+E*HE+F*NE
b. Where:
c. BEC is the total baseline energy consumption;
d. FC is a fixed component, a constant (this constant may be adjusted from future energy evaluation of a structure);
e. A is a constant;
f. SF is the square footage (variable 1);
g. B is a constant;
h. EB is the number of equipment B that operates continuously (variable 2);
i. C is a constant;
j. EC is the number of equipment C that operates continuously (variable 3);
k. D is a constant;
l. HD is the hours of operations of equipment D during the period (variable 4);
m. E is a constant;
n. HE is the hours of operations of equipment E during the period (variable 5);
o. F is a constant; and
p. NE is the number of employees (variable 6).

13. A computer-based method of creating a cash flow based on energy savings, comprising:
a. using a computing device, calculating a cost savings based on a first value of energy consumption measured before an energy efficiency improvement and a second value of energy consumption measured after the energy efficiency improvement; and
b. determining a cash flow based on the calculated cost savings.

14. The method of claim 13, wherein the determined cash flow is based on a projected value of the calculated cost savings, spread over a predetermined period of time.

15. The method of claim 13, wherein the cost savings is determined by a method including:
a. determining an energy consumption baseline;
b. developing a baseline formula using the determined energy consumption baseline using a computing device;
c. using the developed baseline formula to determine a value of energy consumption following a change in at least one variable in the developed baseline formula; and
d. calculating the cost savings based on the determined energy consumption baseline and the value of energy consumption following the change.

16. A method of creating a financial security, comprising:
a. using a computing device, determining the value of at least two cash flows created by energy savings;
b. using the determined value, creating a financial security collateralized on the at least two cash flows.

17. The method of claim 16, wherein the cash flows are associated with energy saving backed securities.

18. The method of claim 16, wherein the cash flows are determined by a method including:
a. using a computing device, calculating a cost savings based on a first value of energy consumption measured before an energy efficiency improvement and a second value of energy consumption measured after the energy efficiency improvement; and
b. determining a cash flow based on the calculated cost savings.

19. The method of claim 18, wherein the cost savings is determined by a method including:
a. determining an energy consumption baseline;
b. developing a baseline formula using the determined energy consumption baseline using a computing device;
c. using the developed baseline formula to determine a value of energy consumption following a change in at least one variable in the developed baseline formula; and
d. calculating the cost savings based on the determined energy consumption baseline and the value of energy consumption following the change.
